(19) United States
(12) Patent Application Publication
(10) Pub. No.: US 2013/0101402 A1
(43) Pub. Date: Apr. 25, 2013

(54) FAN HOUSING WITH COOLING SLOTS

(71) Applicants: Seth E. Rosen, Middletown, CT (US); Brent J. Merritt, Southwick, MA (US)

(72) Inventors: Seth E. Rosen, Middletown, CT (US); Brent J. Merritt, Southwick, MA (US)

(73) Assignee: HAMILTON SUNDSTRAND CORPORATION, Windsor Locks, CT (US)

(21) Appl. No.: 13/279,576

(22) Filed: Oct. 24, 2011

(51) Int. Cl. F04D 29/58; F02K 3/04; B23P 15/00; F01D 25/12

(52) U.S. Cl. 415/180; 415/177; 29/888.025

(57) ABSTRACT

A fan housing for a ram air fan includes an outer portion to connect the fan housing to ram air fan components; a tubular portion; a plurality of struts connecting the outer portion and the tubular portion; and a central disc portion inside of the tubular portion. The central disc portion comprises six cooling slots around an outer circumference.

### BACKGROUND

The present invention relates to an environmental control system. In particular, the invention relates to a ram air fan assembly for an environmental control system for an aircraft.

An environmental control system (ECS) aboard an aircraft provides conditioned air to an aircraft cabin. Conditioned air is air at a temperature, pressure, and humidity desirable for aircraft passenger comfort and safety. At or near ground level, the ambient air temperature and/or humidity is often sufficiently high that the air must be cooled as part of the conditioning process before being delivered to the aircraft cabin. At flight altitude, ambient air is often far cooler than desired, but at such a low pressure that it must be compressed to an acceptable pressure as part of the conditioning process. Compressing ambient air at flight altitude heats the resulting pressurized air sufficiently that it must be cooled, even if the ambient air temperature is very low. Thus, under most conditions, heat must be removed from air by the ECS before the air is delivered to the aircraft cabin. As heat is removed from the air, it is dissipated by the ECS into a separate stream of air that flows into the ECS, across heat exchangers in the ECS, and out of the aircraft, carrying the excess heat with it. Under conditions where the aircraft is moving fast enough, the pressure of air ramming into the aircraft is sufficient to move enough air through the ECS and over the heat exchangers to remove the excess heat.

While ram air works well under normal flight conditions, at lower flight speeds, or when the aircraft is on the ground, ram air pressure is too low to provide enough air flow across the heat exchangers for sufficient heat removal from the ECS. Under these conditions, a fan within the ECS is employed to provide the necessary airflow across the ECS heat exchangers. This fan is called a ram air fan.

As with any system aboard an aircraft, there is great value in an improved ram air fan that includes innovative components designed to improve the operational efficiency of the ram air fan or to reduce its weight.

### SUMMARY

A fan housing for a ram air fan includes an outer portion to connect the fan housing to ram air fan components; a tubular portion; a plurality of struts connecting the outer portion and the tubular portion; and a central disc portion inside of the tubular portion. The central disc portion comprises six cooling slots around an outer circumference.

### BRIEF DESCRIPTION OF THE DRAWINGS

FIG. 1A is a cross-sectional view of a ram air fan assembly.

FIG. 1B is a view of FIG. 1A with arrows to indicate cooling flow.

FIG. 2A shows a perspective view of a fan housing.

FIG. 2B shows a side view of FIG. 2A.

FIG. 2C shows a front view FIG. 2A.

### DETAILED DESCRIPTION

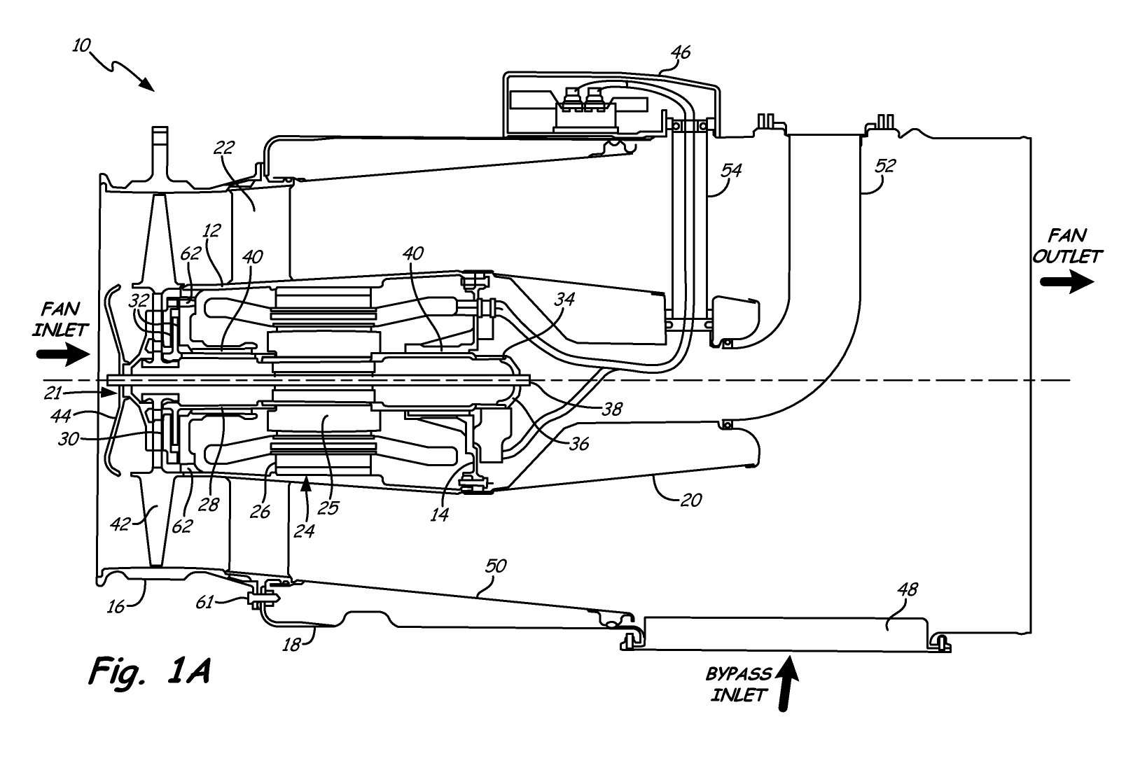

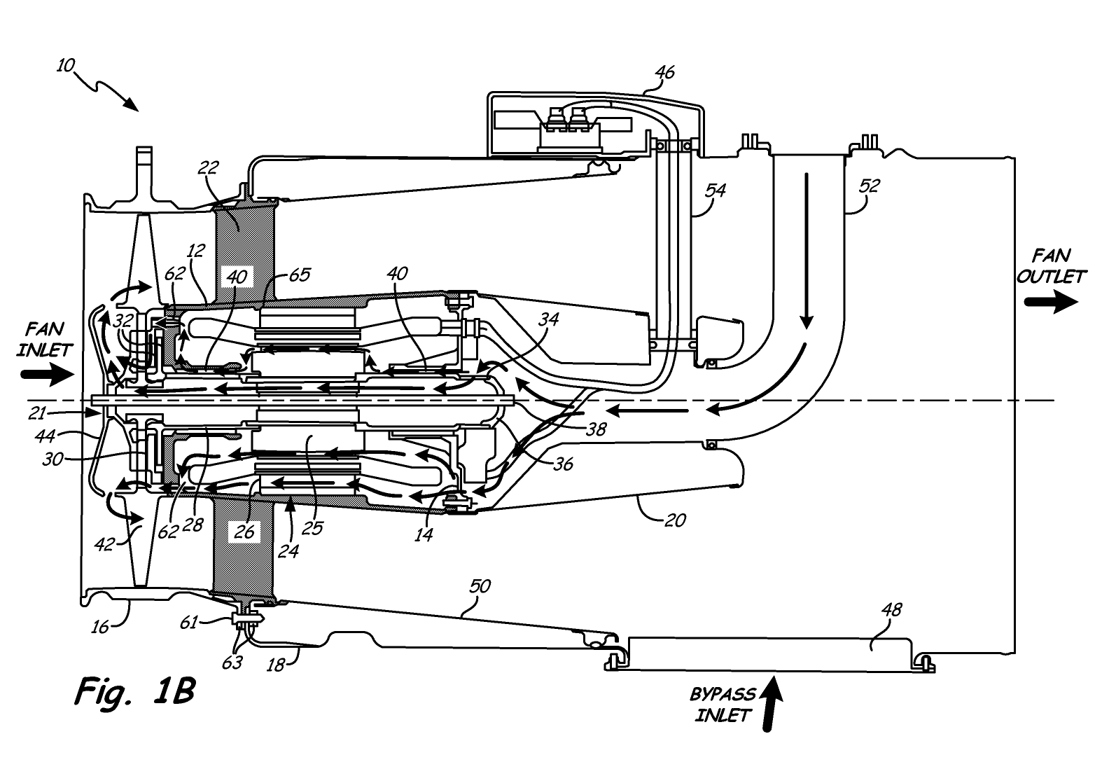

FIG. 1A illustrates a ram fan air assembly incorporating the present invention. Ram air fan assembly 10 includes fan housing 12, bearing housing 14, inlet housing 16, outer housing 18, and inner housing 20. Fan housing 12 (with slots 62) includes fan struts 22, motor 24 (including motor rotor 25 and motor stator 26), thrust shaft 28, thrust plate 30, and thrust bearings 32. Bearing housing 14 includes journal bearing shaft 34 and shaft cap 36. Fan housing 12 and bearing housing 14 together include tie rod 38 and journal bearings 40. Inlet housing 16 contains fan rotor 42 and inlet shroud 44, in addition to a portion of tie rod 38. Outer housing 18 includes terminal box 46 and plenum 48. Within outer housing 18 are diffuser 50, motor bearing cooling tube 52, and wire transfer tube 54. A fan inlet is a source of air to be moved by ram air fan assembly 10 in the absence of sufficient ram air pressure. A bypass inlet is a source of air to that moves through ram air fan assembly 10 when sufficient ram air pressure is available.

As illustrated in FIG. 1A, inlet housing 16 and outer housing 18 are attached to fan housing 12 radially outward from fan struts 22. Bearing housing 14 is attached to fan housing 12, and inner housing 20 connects motor bearing cooling tube 52 and wire transfer tube 54 to bearing housing 14. Motor bearing cooling tube 52 connects inner housing 20 to a source of cooling air at outer housing 18. Wire transfer tube 54 connects inner housing 20 to outer housing 18 at terminal box 46. Motor stator 26 and thrust plate 30 attach to fan housing 12. Motor rotor 25 is contained within motor stator 26 and connects journal bearing shaft 34 to thrust shaft 28. Journal bearing shaft 34, motor rotor 25, and thrust shaft 28 define an axis of rotation for ram fan assembly 10. Fan rotor 42 is attached to thrust shaft 28 with tie rod 38 extending along the axis of rotation from shaft cap 36 at the end of journal bearing shaft 34 through motor rotor 25, thrust shaft 28, and fan rotor 42 to inlet shroud 44. Nuts (not shown) secure shaft cap 36 to journal bearing shaft 34 on one end of tie rod 38 and inlet shroud 44 to fan rotor 42 at opposite end of tie rod 38. Thrust plate 30 and fan housing 12 contain a flange-like portion of thrust shaft 28, with thrust bearings 32 positioned between the flange-like portion of thrust shaft 28 and thrust plate 30; and between the flange-like portion of thrust shaft 28 and fan housing 12. Journal bearings 40 are positioned between journal bearing shaft 24 and bearing housing 14; and between thrust shaft 28 and fan housing 12. Inlet shroud 44, fan rotor 42, and a portion of fan housing 12 are contained within inlet housing 16. Diffuser 50 is attached to an inner surface of outer housing 18. Plenum 48 is a portion of outer housing 18 that connects ram air fan assembly 10 to the bypass inlet. Inlet housing 16 is connected to the fan inlet and outer housing 18 is connected to the fan outlet.

In operation, ram air fan assembly 10 is installed into an environmental control system aboard an aircraft and connected to the fan inlet, the bypass inlet, and the fan outlet. When the aircraft does not move fast enough to generate sufficient ram air pressure to meet the cooling needs of the ECS, power is supplied to motor stator 26 by wires running from terminal box 46, through wire transfer tube 54, inner housing 20, and bearing housing 14. Energizing motor stator 26 causes rotor 24 to rotate about the axis of rotation of ram fan assembly 10, rotating connected journal bearing shaft 34 and thrust shaft 28. Fan rotor 42 and inlet shroud 44 also rotate by way of their connection to thrust shaft 28. Journal bearings 40 and thrust bearings 32 provide low friction support for the rotating components. As fan rotor 42 rotates, it moves air from the fan inlet, through inlet housing 20, past fan struts 22 and into the space between fan housing 12 and outer housing 18, increasing the air pressure in outer housing 18. As the air moves through outer housing 18, it flows past diffuser 50 and inner housing 20, where the air pressure is reduced due to the shape of diffuser 50 and the shape of inner housing 20. Once past inner housing 20, the air moves out of outer housing 18 at the fan outlet.

Components within bearing housing 14 and fan housing 12, especially thrust bearings 32, journal bearings 40 and motor 24; generate significant heat and must be cooled. A cooling flow is provided through inner cooling area, which consists of bearing housing 14 and fan housing 12.

FIG. 1B shows the cross ram air fan assembly 10 of FIG. 1A with fan housing 12 shaded for viewing purposes only, and including arrows showing cooling flow.

As shown by arrows, cooling air is provided by motor bearing cooling tube 52 which directs a flow of cooling air to inner housing 20. Inner housing 20 directs flow of cooling air to bearing housing 14, where it flows past components in bearing housing 14 and fan housing 12 to cool bearings 40 and motor 24. Cooling air then flows through slots 62 in fan housing 12 and by bearings 32 before exiting inner cooling area through cooling holes in rotor 42.

Fan housing 12 can be installed into ram air fan 10 by first heating fan housing to a maximum of about 400 degrees F. (about 477 K) for about 20 minutes, and then installing over motor stator 26 and seating onto inner shoulder 65 of housing bore. Outer housing 18 and inlet housing 16 are oriented to line up with the bolt pattern on fan housing 12. Mount bracket 63 is lined up, and fan housing 12 is bolted between inlet housing 16, outer housing 18 and mount bracket 63 using fasteners.

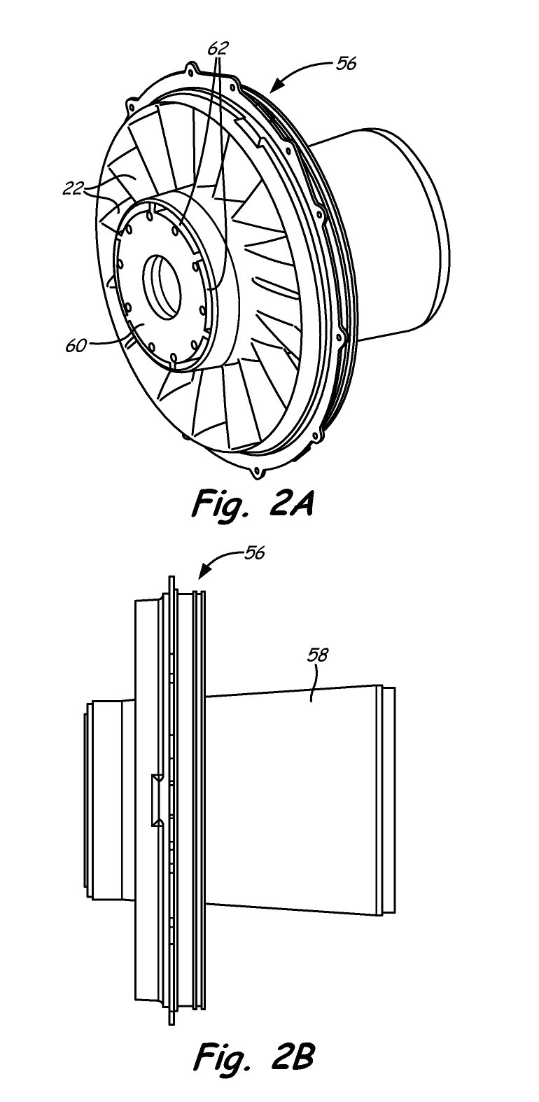

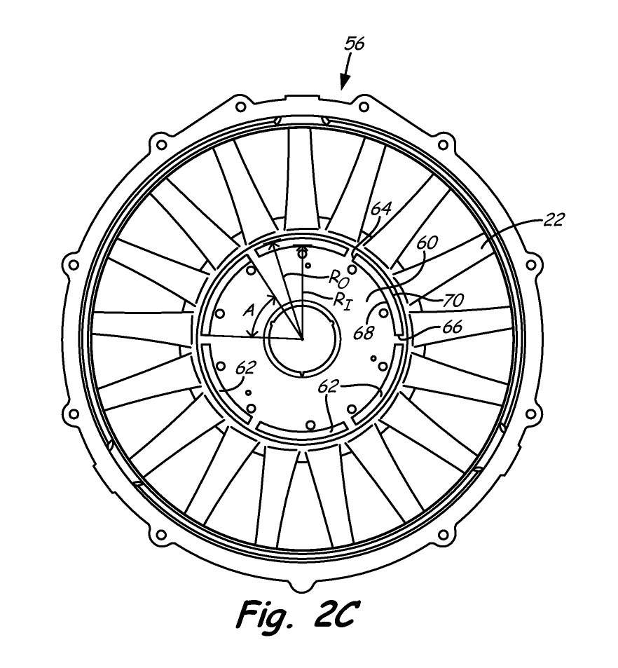

FIG. 2A shows a perspective view of fan housing 12. FIG. 2B shows a side view of FIG. 2A, and FIG. 2C shows a front view FIG. 2A. Fan housing 12 includes struts 22, outer portion 56, tubular portion 58, and central disc portion 60 with slots 62.

Fan housing 12 is typically made as one integral part of aluminum (including alloys) or another material that is situated to ram air fan 10 requirements. As shown in FIGS. 1A-1B, fan housing 12 connects to inlet housing 16 and outer housing 18 at outer portion with bolts 61. Six slots 62 are located circumferentially around an outer portion of central disc 60. Slots 62 each have a first end 64, second end 66, inner side 68 and outer side 70. Dimensions shown are angle A between first end 64 and second end 66, inner radius R_{I} from center of central disc portion 60 to outer side 70 and outer radius R_{O} from center of central disc portion 60 to outer side 70.

Slots 62 are typically in an arcuate shape and are equally spaced circumferentially around central disc 60. Angle A between first end 64 and second end 66 of each slot 62 is about 55 degrees. Inner radius R_{I} from center of central disc 60 to inner side 68 of each slot is about 2.875 inches (73.025 mm). Outer radius R_{O} from center of central disc portion to outer side 70 is 3.140 inches (79.756 mm). The width of slots 62 (R_{I} to R_{O}) is 0.265 inches (6.731 mm). Slots 62 are located about 0.083 inches (2.108 mm) radially inward from the outer circumference of the central disc 60. Slots 62 comprise about 91.67% of area of disc 60 between R_{I} and R_{O} and about 14% of overall area of central disc 60.

Slots 62 control the cooling air flow through inner cooling area to cool bearings 32, 40 and motor 24, while maintaining structural integrity of fan housing 12. As mentioned in relation to FIG. 1B, motor bearing cooling tube 52 delivers cooling air to inner housing 20, which sends the cooling air to bearing housing 14 and then fan housing 12. Motor 24 heats to significant temperatures during operation and requires large amounts of cooling. This cooling is critical to performance and reliability. Cooling air is required to maintain a high level of motor 24 performance and ensure a long life. Cooling air is also required to ensure a long life for thrust bearings 32 and journal bearings 40. Placing six large slots 62 with the dimensions shown at locations around outer portion of central disc 60 allows for proper cooling of bearings 32, 40 and motor 24.

In summary, the addition of a plurality of large cooling slots around an outer circumference of central disc portion 60 of fan housing 12 allows for the desired airflow in an inner cooling system of a fan while still maintaining structural integrity in fan housing 12. This controlling of the airflow allows for the cooling of inner components, such as a motor and bearings, to prevent overheating and burning up bearings 32, 40 which could lead to ram air fan 12 failure.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fan housing for a ram air fan, the fan housing comprising:
an outer portion to connect the fan housing to ram air fan components;
a tubular portion;
a plurality of struts connecting the outer portion and the tubular portion; and
a central disc portion inside of the tubular portion, wherein the central disc portion comprises six cooling slots around an outer circumference.

2. The fan housing of claim 1, wherein the cooling slots are arcuate and equally spaced around the central disc portion.

3. The fan housing of claim 2, wherein each slot has an inner side of about 2.875 inches (73.025 mm) radially from central disc portion center and an outer side of about 3.140 inches (79.756 mm) radially from central disc portion center.

4. The fan housing of claim 3, wherein each slot has a first end and a second end, and the first end is at an angle of about 55 degrees from the second end.

5. The fan housing of claim 1, wherein the housing is one integral part.

6. The fan housing of claim 1, wherein slots are located about 0.083 inches (2.108 mm) radially inward from the outer circumference of the central disc portion.

7. A cooling flow system for a motor and bearings of a ram air fan, the system comprising:
an inner cooling area housing the motor and bearings to intake air; and
a fan housing defining a portion of the inner cooling area, the fan housing comprising:
an outer portion to connect the fan housing to ram air fan components;
a tubular portion;
a plurality of struts connecting the outer portion and the tubular portion; and
a central disc portion inside of the tubular portion, wherein the central disc portion comprises a plurality of cooling slots around an outer circumference.

8. The cooling flow system of claim 7, wherein the central disc portion has six cooling slots equally spaced circumferentially.

9. The cooling flow system of claim 8, wherein each slot has an inner side of about 2.875 inches (73.025 mm) radially from central disc portion center and an outer side of about 3.140 inches (79.756 mm) radially from central disc portion center.

10. The cooling flow system of claim 9, wherein each slot has a first end and a second end, and the first end is at an angle of about 55 degrees from the second end.

11. The cooling flow system of claim 9, wherein the housing is one integral part.

12. The fan housing of claim 7, wherein the slots make up about 14% of the area of the central disc portion.

13. A bearing cooling system for a ram air fan comprising:
a fan housing with a central disc; and
a plurality of cooling slots located circumferentially around an outer portion of the central disc, wherein each slot has an inner side with an inner radius of about 2.875 inches (73.025 mm) from central disc portion center and an outer side with an outer radius of about 3.140 inches (79.756 mm) from central disc portion center.

14. The bearing cooling system of claim 13, wherein the central disc contains six arcuate cooling slots.

15. The bearing cooling system of claim 13, wherein each slot has a first end and a second end, and the first end is at an angle of about 55 degrees from the second end.

16. The bearing cooling system of claim 13, wherein the fan housing further comprises:
an outer portion to connect the fan housing to other ram air fan components;
a tubular portion connecting to and surrounding the central disc; and
a plurality of struts connecting the outer portion and the tubular portion.

17. A method of installing a fan housing in a ram air fan with a motor stator, a housing bore with an inner shoulder, an inlet housing, an outer housing, and a mount bracket, the method comprising:
heating the fan housing;
orienting the fan housing over the motor stator;
seating the fan housing onto an inner shoulder of the housing bore;
orienting the outer housing and inlet housing to line up with the fan housing;
lining up the mount bracket; and
bolting the fan housing, the inlet housing, the outer housing and the mount bracket together using fasteners, wherein the fan housing comprises a central disc portion with a plurality of cooling slots around an outer circumference of the central disc.

18. The method of claim 17, wherein the step of heating the fan housing comprises:
heating the fan housing up to about 400 degrees F. (about 477 K).

19. The method of claim 18, wherein the step of heating the fan housing further comprises:
heating the fan housing for about 20 minutes.
